(19) United States
(12) Patent Application Publication
(10) Pub. No.: US 2018/0355105 A1
(43) Pub. Date: Dec. 13, 2018

(54) SELF-CUREABLE AND LOW TEMPERATURE CUREABLE POLYESTERS

(71) Applicant: Eastman Chemical Company, Kingsport, TN (US)

(72) Inventors: Thauming Kuo, Kingsport, TN (US); Phillip Bryan Hall, Jonesborough, TN (US)

(73) Assignee: Eastman Chemical Company, Kingsport, TN (US)

(21) Appl. No.: 15/621,296

(22) Filed: Jun. 13, 2017

(51) Int. Cl. C08G 63/91; C08G 63/47; C08G 63/82

(52) U.S. Cl. CPC C08G 63/918; C08G 63/82; C08G 63/47

(57) ABSTRACT

Polyesters having both α,β-unsaturated groups and moieties containing activated methylene or methine groups, such as those of beta-ketoacetate and malonate, are curable in the presence of a base catalysts to form crosslinked networks. Formulations based on such polyesters are suitable for use in coatings and adhesive applications, and have the characteristics of curing at temperatures less than 230° C. without the use of isocyanates.

### FIELD OF THE INVENTION

This invention pertains to polyesters. In some embodiments, this invention pertains to self-curing and low temperature curing polyesters for use in coating and adhesive compositions.

### BACKGROUND OF THE INVENTION

Thermosetting compositions based on isocyanate crosslinkers are widely used for coating and adhesive applications. Such systems are curable at room temperature or low temperatures (e.g. <80° C.) and are capable of providing the desirable properties for a variety of applications. However, there have been increasing health concerns associated with the production and the use of isocyanate compounds and the formulations based on isocyanates. Thus, there is a need for a crosslinking system that is isocyanate free. Further, it is desirable that the system not generate by-products upon crosslinking, which can be detrimental to film formation or other desirable properties. Since the isocyanate crosslinkers are generally used for low-temperature curing, in order to replace them, the new system must be curable at similar temperatures. This is particularly challenging because organic reactions generally require the use of heat to overcome the energy that is needed for the reactions to occur. This invention provides a novel crosslinking system that is isocyanate free, curable at low temperatures, has no Volatile Organic Components (VOC) or has low VOC, and is suitable for applications in coatings, such as automotive, industrial maintenance, and furniture, and in adhesives such as laminating adhesive. The low-temperature curable composition is especially suitable for field-applied industrial maintenance coatings, automotive refinish coatings, wood coatings, and marine craft gelcoats.

### SUMMARY OF THE INVENTION

In one embodiment, this invention is a composition comprising a polyester (A) comprising the residues of a first compound (I) comprising an α,β-unsaturated carboxyl compound having at least one carboxylic acid or anhydride group having at least one unsaturation in the position that is α,β relative to said carboxylic acid or anhydride group and not located on an aromatic ring, a second compound (II) having an activated methylene or methine group; and a basic catalyst (B).

In another embodiment an α,β-unsaturated group containing polyester polyol can be prepared by reacting a first compound (I) having an α,β-unsaturated group, such as maleic anhydride, with other monomers typically used for polyester synthesis.

Thus, in a further embodiment, this invention provides a self-curable polyester, which is an acetoacetate-functionalized unsaturated polyester comprising the reaction product of:
I. an unsaturated polyester in an amount from about 50 to about 97 weight percent, based on the total weight of (I) and (II), comprising the residues of:
   a. a hydroxyl component comprising:
      i. a diol in an amount ranging from 70 to 100 mole percent, based on the total moles of (i) and (ii); and
      ii. a polyol in an amount ranging from 0 to 30 mole percent, based on the total moles of (i) and (ii);
   b. an α,β-unsaturated carboxyl compound; and
   c. optionally a carboxyl component, other than said α,β-unsaturated carboxyl compound (b), comprising a polycarboxylic acid compound, a derivative of polycarboxylic acid compound, or a combination thereof, and
II. an alkyl acetoacetate and/or diketene in an amount ranging from about 3 to about 50 weight percent, based on the total weight of (I) and (II).

In another embodiment the invention is a composition comprising:
A. a self-curable polyester comprising the residues of:
   a. a hydroxyl component comprising:
      i. a diol in an amount ranging from 70 to 100 mole percent, based on the total moles of (i) and (ii); and
      ii. a polyol in an amount ranging from 0 to 30 mole percent, based on the total moles of (i) and (ii);
   b. an α,β-unsaturated carboxyl compound,
   c. malonic acid, its ester, or a combination thereof, and
   d. optionally a carboxyl component other than said α,β-unsaturated carboxyl compound (b), and other than said malonic acid and/or its ester (c), comprising a polycarboxylic acid compound, a derivative of polycarboxylic acid compound, or a combination thereof.
   The mole percent of the diol component of (a)(i) can be 70 to 100, 80 to 97, or 85 to 95, and the mole percent of the polyol of (a)(ii) can be 0 to 30, 3 to 20, or 5 to 15, based on the total moles of (i) and (ii); and
B. a basic catalyst.

In another embodiment the invention is a composition comprising:
A. a polyester comprising the residues of:
   I. a first compound having an α,β-unsaturated group; and
   II. a second compound having an activated methylene or methine group; wherein said first compound is an α,β-unsaturated carboxyl compound having at least one carboxylic acid or anhydride group, and having at least one unsaturation in the position that is α,β relative to said carboxylic acid or anhydride group and not located on an aromatic ring; and wherein said second compound is one or more compounds selected from the group consisting of diketene, β-ketotoacetate, and malonate;
B. an amino crosslinker; and
C. an acid catalyst.

### DETAILED DESCRIPTION

Unless otherwise indicated, all numbers expressing quantities of ingredients, properties such as molecular weight, reaction conditions, and so forth used in the specification and claims are to be understood as being modified in all instances by the term “about.” Unless indicated to the contrary, the numerical parameters set forth in the following specification and attached claims are approximations that may vary depending upon the desired properties sought to be obtained by the present invention. At the very least, each numerical parameter should be construed in light of the number of reported significant digits and by applying ordinary rounding techniques. Further, the ranges stated in this disclosure and the claims are intended to include the entire range specifications and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

As used in the specification and the appended claims, the singular forms “a,” “an” and “the” include their plural referents unless the context clearly dictates otherwise. For example, a reference to a “polyester,” a “dicarboxylic acid”, a “residue” is synonymous with “at least one” or “one or more” polyesters, dicarboxylic acids, or residues and is thus intended to refer to both a single or plurality of polyesters, dicarboxylic acids, or residues. In addition, references to a composition containing or including “an” ingredient or “a” polyester is intended to include other ingredients or other polyesters, respectively, in addition to the one named. The terms “containing” or “including” are intended to be synonymous with the term “comprising”, meaning that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

Also, it is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

The term “residue”, as used herein in reference to the polymers described herein, means any organic structure incorporated into a polymer through a polycondensation or ring opening reaction involving the corresponding monomer. It will also be understood by persons having ordinary skill in the art, that the residues associated within the various curable polyesters of the invention can be derived from the parent monomer compound itself or any derivative of the parent compound. For example, the dicarboxylic acid residues referred to in the polymers of the invention may be derived from a dicarboxylic acid monomer or its associated acid halides, esters, salts, anhydrides, or mixtures thereof. Thus, as used herein, the term “dicarboxylic acid” is intended to include dicarboxylic acids and any derivative of a dicarboxylic acid, including its associated acid halides, esters, half esters, salts, half salts, anhydrides, mixed anhydrides, or mixtures thereof, useful in a polycondensation process with a diol to make a curable, aliphatic polyester.

The term “α,β-unsaturated carboxyl compound” as used herein means a compound having at least one carboxylic acid or anhydride group, and having at least one unsaturation in the position that is α,β relative to a carbonyl group and not located on an aromatic ring.

The present inventors have discovered that polyesters having both α,β-unsaturated groups and moieties containing activated methylene or methine groups, such as those of beta-ketoacetate and malonate, are self-curable in the presence of a basic catalyst. As used herein the term “self-curable polyesters” is intended to mean polyesters that are curable at temperatures from about room temperature to about 230° C. to form crosslinked networks. Formulations based on such polyesters are suitable for coating as well as adhesive applications, which have the much-desired characteristics of low-temperature curing without the use of isocyanates.

In one embodiment of the present invention, there is provided a curable composition comprising:
A. a self-curable polyester comprising the residues of
   I. a first compound having an α,β-unsaturated group and
   II. a second compound having an activated methylene or methine group,
wherein the first compound is an α,β-unsaturated carboxyl compound having at least one carboxylic acid or anhydride group, and having at least one unsaturation in the position that is α,β relative to said carboxylic acid or anhydride group and not located on an aromatic ring; and wherein the second compound is one or more compounds selected from the group consisting of diketene, β-ketotoacetate, and malonate; and
B. a basic catalyst.

The polyester has a reactive functional group, typically a hydroxyl group or carboxyl group, used for the purpose of later reacting with a crosslinker in a coating or adhesive formulation. The functional group is controlled by having either excess hydroxyl (from diol or polyol) or acid (from dicarboxylic acid or tricarboxylic acid) in the polyester resin composition. The desired crosslinking pathway will determine whether the polyester resin will be hydroxyl-terminated or carboxylic acid-terminated. This concept is known to those skilled in the art and described, for example, in Organic Coatings Science and Technology, 2nd ed., p. 246-257, by Z. Wicks, F. Jones, and S. Pappas, Wiley, New York, 1999.

In some embodiments, first compound (I) is α,β-unsaturated carboxyl compound such as, but are not limited to, maleic anhydride, maleic acid, fumaric acid, itaconic anhydride, itaconic acid, citraconic anhydride, citraconic acid, aconitic acid, aconitic anhydride, oxalocitraconic acid and its anhydride, mesaconic acid or its anhydride, phenyl maleic acid or its anhydride, t-butyl maleic acid or its anhydride, monomethyl fumarate, monobutyl fumarate, methyl maleic acid or its anhydride, or mixtures thereof. In addition, the esters of said acids such as, for example, dimethyl maleate, dimethyl fumarate, dimethyl itaconate, diethyl maleate, diethyl fumarate, diethyl itaconate, and the like are also suitable.

In other embodiments, first compound (I) is selected from the group consisting of maleic anhydride, maleic acid, fumaric acid, itaconic acid, and itaconic anhydride.

The second compound (II) having an activated methylene or methine group is a compound having a functionality selected from the group of diketene (Formula 1), β-ketotoacetate (Formula 2), and malonate (Formula 3), wherein R is an alkyl group, R′ and R″ are each independently hydrogen or alkyl group.

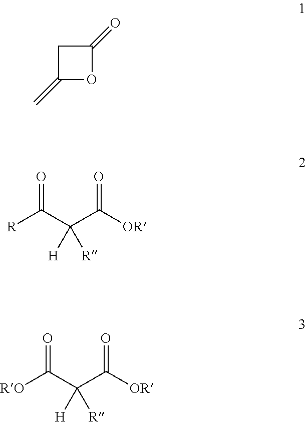

Examples of the second compound (II) include diketene, t-butyl acetoacetate, methyl acetoacetate, ethyl acetoacetate, n-propyl acetoacetate, isopropyl acetoacetate, n-butyl acetoacetate, malonic acid, dimethyl malonate, and diethyl malonate.

In one embodiment, the self-curable polyester (A) is an acetoacetate-functional polyester having one or more α,β-unsaturated groups in the polyester backbone. Such a polyester can be prepared by reacting an α,β-unsaturated group containing polyester polyol, for example, a polyester having a hydroxyl number of at least 5, desirably a hydroxyl number of about 30 to 200, with diketene or a compound having the beta-ketoacetate moiety such as t-butyl acetoacetate (tBAA). Various methods for the preparation of acetoacetylated polyester coating resins have been described by Witzeman et al. in the Journal of Coatings Technology, Vol. 62, No. 789, pp. 101-112 (1990). Suitable amounts of each in a reaction mixture include from about 60 to about 97, 70 to 97, 80 to 94, or 85 to 90 wt. % of the polyester resin and from about 3 to about 40, 3 to 30, 6 to 20, or 10 to 15 wt. % of the compound having a beta-ketoacetate moiety or a diketene can be reacted together, wherein the weight percents are based on the total weight of the polyester resin and the compound having the beta-ketoacetate moiety.

In another embodiment, said acetoacetate functional polyester comprises the reaction product (or residues) of (1) from about 50 to about 97 weight percent of an α,β-unsaturated group containing polyester polyol and (2) from about 3 to about 50 weight percent of an alkyl acetoacetate or diketene, wherein the weight percentages are based on the total weight of (1) and (2).

In another embodiment, said α,β-unsaturated group containing polyester polyol (1) has a hydroxyl number of at least 5 mgKOH/g. In another embodiment the polyester polyol (1) has a hydroxyl number of 30 to 200. In yet another embodiment the polyester polyol (1) has a hydroxyl number of 50 to 150. The weight percent of (1) may be 50 to 97, 60 to 95, 65 to 93, 70 to 90, or 75 to 88 and (2) may be 3 to 50, 5 to 40, 7 to 35, 10 to 30, or 12 to 25.

Desirably, the acid number of the α,β-unsaturated group containing polyester polyol (1) is from 0 to about 15, from 0 to about 10, or from 0 to 5 mg KOH/g. Low acid numbers are desirable since the curable composition of the invention requires the use of a base catalyst. Higher acid numbers can deactivate the base catalyst.

Said α,β-unsaturated group containing polyester polyol in turn can be prepared by reacting the first compound (I) having an α,β-unsaturated group, such as maleic anhydride, with other monomers typically used for polyester synthesis.

Thus, in a further embodiment, this invention provides a self-curable polyester, which is an acetoacetate-functionalized unsaturated polyester comprising the reaction product of:
I. an unsaturated polyester in an amount from about 50 to about 97 weight percent, based on the total weight of (I) and (II), comprising the residues of
   a. a hydroxyl component comprising
      i. a diol in an amount ranging from 70 to 100 mole percent, based on the total moles of (i) and (ii), and
      ii. a polyol in an amount ranging from 0 to 30 mole percent, based on the total moles of (i) and (ii),
   b. an α,β-unsaturated carboxyl compound,
   c. optionally a carboxyl component other than said α,β-unsaturated carboxyl compound (b), comprising a polycarboxylic acid compound, a derivative of polycarboxylic acid compound, or a combination thereof, and
II. an alkyl acetoacetate and/or diketene in an amount ranging from about 3 to about 50 weight percent, based on the total weight of (I) and (II).

The mole percent of the diol component of (a)(i) can be 70 to 100, 80 to 97, or 85 to 95, and the polyol of (a)(ii) can be 0 to 30, 3 to 20, or 5 to 15, based on the total moles of (i) and (ii).

The mole percent of the α,β-unsaturated carboxyl compound (b) can be 10 to 100, 20 to 90, 30 to 80, 35 to 70, or 40 to 60, based on the total moles of the carboxyl components, (b) and (c). In one embodiment, the mole percent is 35 to 70 or 40 to 60.

The weight percent of the alkyl acetoacetate and/or diketene (II) can be 3 to 50, 5 to 40, 7 to 35, 10 to 30, or 12 to 25, based on the total weight of (I) and (II).

In some embodiments the hydroxyl component (a) include dos such as 2,2,4,4-tetraalkylcyclobutane-1,3-diol (TACD), 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, hydrogenated bisphenol A, ethylene glycol, propylene glycol, diethylene glycol, dipropylene glycol, triethylene glycol, tetraethylene glycol, and polyethylene glycol, and polyols such as 1,1,1-trimethylol propane, 1,1,1-trimethylolethane, glycerin, pentaerythritol, erythritol, threitol, dipentaerythritol, sorbitol, and combinations thereof.

Examples of said 2,2,4,4-tetraalkylcyclobutane-1,3-diols (TACD) include 2,2,4,4-tetramethylcyclobutane-1,3-diol (TMCD), 2,2,4,4-tetraethylcyclobutane-1,3-diol, 2,2,4,4-tetra-n-propylcyclobutane-1,3-diol, and 2,2,4,4-tetra-n-butylcyclobutane-1,3-diol. In some embodiments, the diol (a)(i) comprises one or more selected from the group consisting of 2,2,4,4-tetramethylcyclobutane-1,3-diol, 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 1,4-butanediol, and 1,6-hexanediol. In other embodiments, the polyol (a)(ii) is selected from 1,1,1-trimethylol propane, 1,1,1-trimethylolethane, glycerin, and pentaerythritol.

In some embodiments the α,β-unsaturated carboxyl compound (b) is a compound having an α,β-unsaturated group such as, but are not limited to, maleic anhydride, maleic acid, fumaric acid, itaconic anhydride, itaconic acid, citraconic anhydride, citraconic acid, aconitic acid, aconitic anhydride oxalocitraconic acid and its anhydride, mesaconic acid or its anhydride, phenyl maleic acid or its anhydride, t-butyl maleic acid or its anhydride, monomethyl fumarate, monobutyl fumarate, methyl maleic acid or its anhydride, or mixtures thereof. In addition, the esters of said acids such as, for example, dimethyl maleate, dimethyl fumarate, dimethyl itaconate, diethyl maleate, diethyl fumarate, diethyl itaconate, and the like are also suitable

In some embodiments the carboxyl component (c) may be a polycarboxylic acid compound, a derivative of polycarboxylic acid compound, or a combination thereof. Suitable polycarboxylic acid compounds include compounds having at least two carboxylic acid groups. In one aspect, the polycarboxylic acid compound comprises a dicarboxylic acid compound having two carboxylic acid groups, derivatives thereof, or combinations thereof, capable of forming an ester linkage with a polyhydroxyl component. For example, a polyester can be synthesized by using a polyhydroxyl compound and a derivative of a dicarboxylic acid such as, for example, dimethyl ester or other dialkyl esters of the diacid, or diacid chloride or other diacid halides, or acid anhydride. In another aspect, the polycarboxylic acid compound comprises a tricarboxylic acid or anhydride, for example, trimellitic acid or trimellitic anhydride.

Examples of dicarboxylic acids that may be used include aliphatic dicarboxylic acids, alicyclic dicarboxylic acids, aromatic dicarboxylic acids, derivatives of each, or mixtures of two or more of these acids. Thus, suitable dicarboxylic acids include, but are not limited to, isophthalic acid (or dimethyl isophthalate), terephthalic acid (or dimethyl terephthalate), phthalic acid, phthalic anhydride, 1,4-cyclohexane-dicarboxylic acid, 1,3-cyclohexanedicarboxylic acid, hexahydrophthalic anhydride, tetrahydrophthalic anhydride, tetrachlorophthalic anhydride, dodecanedioic acid, sebacic acid, azelaic acid, succinic anhydride, succinic acid, adipic acid, 2,6-naphthalenedicarboxylic acid, glutaric acid, and their derivatives, diglycolic acid; 2,5-norbornanedicarboxylic acid; 1,4-naphthalenedicarboxylic acid; 2,5-naphthalenedicarboxylic acid; diphenic acid; 4,4′-oxydibenzoic acid; 4,4′-sulfonyidibenzoic acid, and mixtures thereof.

In some embodiments, the carboxyl component (c) comprises one or more selected from the group consisting of isophthalic acid (or dimethyl isophthalate), terephthalic acid (or dimethyl terephthalate), phthalic acid, phthalic anhydride, 1,4-cyclohexane-dicarboxylic acid, 1,3-cyclohexanedicarboxylic acid, adipic acid, 2,6-naphthalene-dicarboxylic acid, 1,4-naphthalenedicarboxylic acid; 2,5-naphthalenedicarboxylic acid; hexahydrophthalic anhydride, tetrahydrophthalic anhydride, trimellitic anhydride, succinic anhydride, and succinic acid. In other embodiments, the carboxyl compound (b) is selected from the group consisting of isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, adipic acid, hexahydrophthalic anhydride, and succinic anhydride.

Examples of said alkyl acetoacetate (II) include t-butyl acetoacetate, methyl acetoacetate, ethyl acetoacetate, n-propyl acetoacetate, isopropyl acetoacetate, n-butyl acetoacetate, and the like.

In another embodiment, the self-curable polyester having one or more malonate groups (Formula 3) may be prepared by using malonic acid or its ester, such as dimethyl malonate or diethyl malonate, as an diacid in addition to the first compound (I) having an α,β-unsaturated group for polyester synthesis.

Thus, this invention further provides a self-curable polyester (A) comprising the residues of:
a. a hydroxyl component comprising:
   i. a diol in an amount ranging from 70 to 100 mole percent, based on the total moles of (i) and (ii); and
   ii. a polyol in an amount ranging from 0 to 30 mole percent, based on the total moles of (i) and (ii);
b. an α,β-unsaturated carboxyl compound,
c. malonic acid, its ester, or a combination thereof, and
d. optionally a carboxyl component other than said α,β-unsaturated carboxyl compound (b) and other than said malonic acid and/or its ester (c), comprising a polycarboxylic acid compound, a derivative of polycarboxylic acid compound, or a combination thereof.
The mole percent of the diol component of (a)(i) can be 70 to 100, 80 to 97, or 85 to 95, and the mole percent of the polyol of (a)(ii) can be 0 to 30, 3 to 20, or 5 to 15, based on the total moles of (i) and (ii).

The mole percent of the α,β-unsaturated carboxyl compound (b) can be 10 to 90, 20 to 80, 30 to 70, 30 to 75, or 35 to 70, based on the total moles of the carboxyl components, (b), (c), and (d). In one embodiment, the mole percent is 35 to 70 or 40 to 60.

The mole percent of malonic acid and/or its ester (c) can be 10 to 90, 20 to 80, 30 to 70, 30 to 75, or 35 to 70, based on the total moles of the carboxyl components, (b), (c), and (d). In one embodiment, the mole percent is 20 to 60, or 30 to 50.

In another embodiment, the mole percent of the α,β-unsaturated carboxyl compound (b) is 30 to 50, the mole percent of malonic acid (c) is 30 to 50, and the mole percent of the carboxyl compound (d) is 0 to 40.

Examples of the hydroxyl component (a) and the carboxyl component (d) are the same as those specified for the acetoacetate-functionalized unsaturated polyester.

Examples of the α,β-unsaturated carboxyl compound (b) include maleic anhydride, maleic acid, fumaric acid, itaconic anhydride, itaconic acid, citraconic anhydride, citraconic acid, aconitic acid, aconitic anhydride, oxalocitraconic acid and its anhydride, mesaconic acid or its anhydride, phenyl maleic acid or its anhydride, t-butyl maleic acid or its anhydride, monomethyl fumarate, monobutyl fumarate, methyl maleic acid or its anhydride, or mixtures thereof. In addition, the esters of said acids such as, for example, dimethyl maleate, dimethyl fumarate, dimethyl itaconate, diethyl maleate, diethyl fumarate, diethyl itaconate, and the like are also suitable.

Examples of the ester of malonic acid (c) include dimethyl malonate and diethyl malonate.

The glass transition temperature (Tg) of the self-curable polyester of the present invention may be from −40° C. to 120° C., from −10° C. to 100° C., from 20° C. to 80° C., or from 30° C. to 70° C. Depending on the applications, the polyesters can have low Tg's or high Tg's. For example, low Tg polyesters are more desirable for adhesive applications, while high Tg polyesters are more desirable for coating applications.

The weight average molecular weight (Mw) of the self-curable polyester of the present invention may be from 1,000 to 100,000; from 1,500 to 50,000; from 2,000 to 10,000; or from 2,500 to 5,000 g/mole. The polyester may be linear or branched. The Mw is measured by gel permeation chromatography (GPC) using polystyrene equivalent molecular weight.

The curable composition further comprises a base catalyst (B) in an amount ranging from 0.1 to 10, 0.2 to 7, 0.3 to 6, or 0.5 to 5 weight percent, based on the weight of the self-curable polyester (A).

Examples of the base catalyst include amidine type catalysts such as 1,8-diazabicyclo-[5,4,0]undec-7-ene (DBU), 1,5-diazabicyclo[4.3.0]non-5-ene (DBN), 1,5,7-triazabicyclo[4.4.0]dec-5-ene (TBD), 7-methyl-1,5,7-triazabicyclo[4.4.0]dec-5-ene (MTBD), and 1,1,3,3-tetramethylguanidine (TMG), bicyclic unhindered tertiary amine type catalysts such as 1,4-diazabicyclo[2.2.2]octane (DABCO), tertiary amine type catalysts such as triethylamine and N,N-dimethylethanolamine, quaternary ammonium compound catalysts such as ammonium hydroxide and tetrabutyl ammonium hydroxide, phosphine type catalysts such as triphenyl phosphine and tributyl phosphine, and inorganic bases such as sodium hydroxide and potassium hydroxide, and mixtures thereof. In some embodiments of the invention, the amidine type, the bicyclic unhindered tertiary amine type, and the tertiary amine type catalysts are desirable.

In some embodiments of the invention, the desirable catalyst is the amidine type catalyst, such as 1,8-diazabicyclo-[5.4.0]undec-7-ene (DBU), 1,5-diazabicyclo[4.3.0]non-5-ene (DBN), 1,5,7-triazabicyclo[4.4.0]dec-5-ene (TBD), 7-methyl-1,5,7-triazabicyclo[4.4.0]dec-5-ene (MTBD), and 1,1,3,3-tetramethylguanidine (TMG).

In order to extend the pot life of the curable composition, the base catalyst may be temporarily blocked. For example, an alcohol such as methanol or ethanol may be added to the composition on storage to block the catalyst. When the composition is applied, the alcohol will evaporate and the catalyst de-blocked. A carboxylic acid, such as benzoic acid, acetic acid, or cyanoacetic acid, can also be added to the composition to block the catalyst and subsequently deblock by heating. Such techniques for blocking and deblocking the amidine catalysts have been disclosed in Progress in Organic Coatings, 32 (1997), 137-142 by Arie Noomen.

Thus, in a further embodiment, the curable composition further comprises a catalyst-blocking agent. Examples of such blocking agents include alcohols, such as methanol, ethanol, isopropanol, n-propanol, and the like, and carboxylic acids such as benzoic acid, formic acid, acetic acid, and cyanoacetic acid.

The curable composition is capable of reacting at an ambient temperature in the presence of a base catalyst. In a so-called 2K system, it is required to mix the two components shortly before use to prevent the composition from premature crosslinking and becoming useless. In the present invention, there is no need to add another component other than the base catalyst since the polyester is self-curable. The self-curable polyester is not reactive without a catalyst; thus, it is storage stable. The base catalyst can be added to the curable composition shortly before use to trigger the curing process. A blocked base catalyst may be added to the self-curable polyester for long-term storage. Thus, this invention further provides a one-pack curable composition, which can be stored and used without the need of adding another component to trigger the reaction. The curing occurs when the composition is applied and the catalyst deblocked, for example, by the evaporation of the blocking agent.

The curable composition may be solventless or solvent-based. The solvent-based composition further comprises an organic solvent. Suitable organic solvents include xylene, ketones (for example, methyl amyl ketone and methyl ethyl ketone), 2-butoxyethanol, ethyl-3-ethoxypropionate, toluene, butanol, cyclopentanone, cyclohexanone, ethyl acetate, butyl acetate, and other volatile inert solvents typically used in industrial coatings. The amount of solvents can range from 0% to 70%, 5% to 50%, or 10% to 30% based on the total weight of the curable composition.

In one embodiment, the curable composition is a coating composition suitable for applications in coatings such as automotive, industrial maintenance, metal can, and furniture. The curing temperature for such coating applications can range from room temperature to about 230° C. The low-temperature curable composition is especially suitable for field-applied industrial maintenance coatings, automotive refinish coatings, wood coatings, and marine craft gelcoats. The composition can also be used for architecture coatings, for example, as a replacement for alkyd paint in order to meet the needs for quick drying, reduced dirt pick up, improved block resistance, and eliminating the use of metal driers such as cobalt and zirconium.

In another embodiment, the curable composition is an adhesive composition for applications in adhesives such as laminating adhesive for flexible packaging. The curing temperature for such an adhesive is desirably low temperatures ranging from room temperature to about 80° C.

The curable composition may further comprise an amino crosslinker and/or phenolic resin. Suitable amino crosslinkers include hexamethoxymethyl-melamine, tetramethoxymethylbenzoguanamine, tetramethoxymethylurea, mixed butoxy/methoxy substituted rnethylmelamines, and the like.

Suitable phenolic resins include PHENODUR PR371/70B, PHENODUR® PR 516/60B, PHENODUR® PR 612/80B available from Annex.

There has been a need in the automotive OEM coating industry to reduce the curing temperature from 140° C. currently used to lower temperatures such as 120° C. and 100° C. to save the energy consumption and to increase the production efficiency. The present inventors have discovered that in another embodiment of the invention the self-curable polyester disclosed herein can be formulated with an amino crosslinker and cured at low temperatures such as from about 100° C. to about 140° C. Further, a reduced amount of the amino crosslinker, such as from about 10% to about 30% based on the total weight of polyester and crosslinker, may be used. This is advantageous in that it can improve the acid-etch resistance of the coatings due to the reduction of the weak linkages between polyester and amino crosslinker.

Although a base catalyst can also be used, an acid catalyst is preferred in such formulations comprising an amino crosslinker for baking enamel applications.

Thus, this invention further provides a curable composition comprising:

A. a self-curable polyester of the present invention,

B. an amino crosslinker, and

C. an acid catalyst.

Desirably, the amino crosslinker (B) is in an amount of from about 10 to 30 weight percent based on the total weight of (A) and (B). Suitable amino crosslinkers include hexamethoxymethyl-melamine, tetramethoxymethylbenzoguanamine, tetramethoxymethylurea, mixed butoxy/methoxy substituted methylmelamines, and the like. Examples of the commercial amino crosslinkers include CYMEL 303, CYMEL 327, and CYMEL 1123 available from Allnex.

Examples of the acid catalyst include protonic acids such as p-toluenesulfonic acid, dinonylnaphthalene disulfonic acid, dodecylbenzenesulfonic acid, phosphoric acid, and the like. The acid catalyst may also be Lewis acid or amine-blocked acid catalyst. Desirably, the acid catalyst is in an amount ranging from 0.1 to 2 weight percent, based on the total weight of the polyester (A) and the amino crosslinker (B).

In addition to coating and adhesive applications, the curable composition of this invention can also be used for other applications, such as plastic molding and rubber compounding, where forming polymeric network is desirable.

After formulation, the curable composition can be applied to a substrate or article. Thus, a further aspect of the present invention is a shaped or formed article that has been coated with the curable compositions of the present invention. The substrate can be any common substrate such as paper; polymer films such as polyethylene or polypropylene; wood; metals such as aluminum, steel or galvanized sheeting; glass; urethane elastomers; primed (painted) substrates; and the like. The curable composition can be coated onto a substrate using techniques known in the art, for example, by spraying, draw-down, roll-coating, etc., to form a dried coating having a thickness of about 0.1 to about 4 mils (1 mil=25 μm), or 0.5 to 3, or 0.5 to 2, or 0.5 to 1 mils on the substrate. The coating can be cured at ambient temperatures such as room temperature or by heating to a temperature of about 50° C. to about 200° C. for a time period that typically ranges from about a few seconds to about 60 minutes and allowed to cool. When used as an adhesive, the curable composition can be applied to bond the objects by a method known in the art such as brushing, spraying, nozzle dispensing, roll coating, printing, and curtain coating.

### EXAMPLES

### Example 1. Synthesis of Self-Curable Polyester 1 (SC Polyester 1)

### Unsaturated Polyester 1:

A 2-L kettle with a four-neck lid was equipped with a mechanical stirrer, a thermocouple, a heated partial condenser (115° C.), a Dean-Stark trap, and a chilled condenser (15° C.). To the flask were charged 1,6-hexanediol (HD) (278.2 g, 2.35 mole), 2-methyl-1,3-propanediol (212.1 g, 2.35 mole), trimethylolpropane (TMP) (29.76 g, 0.22 mole), adipic acid (368.2 g, 2.52 mole), and maleic anhydride (MA) (164.7 g, 1.68 mole). The reaction temperature was increased from 100° C. to 160° in 2 hours, a total of 32 g of the distillate was collected. The reaction was allowed to continue at 160° C. for 30 min., at 180° C. for 30 min., at 200° C. for 30 min., at 210° C. for 30 min., and at 230° C. for about 3 hours to yield a clear, viscous mixture. A total of 112 g of the distillate was collected in the Dean-Stark trap. The resulting polyester was allowed to cool to room temperature and subsequently collected. The polyester had an acid number of 4.6 mgKOH/g; a hydroxyl number of 84 mgKOH/g; a glass transition temperature (Tg) of −56° C.; a number average molecular weight (Mn) of 1949 g/mole; and a weight average molecular weight (Mw) of 8098 g/mole.

### Self-Curable Polyester 1 (SC Polyester 1):

The next synthesis was aimed to convert the hydroxyl number of 100 mgKOH/g of the above unsaturated polyester (1) to an acetoacetate number of 100 mgKOH/g. To a 500 mL, three-neck, round-bottom flask equipped with a mechanical stirrer, a heated partial condenser, a Dean-Stark trap, and a water condenser were added the above unsaturated polyester 1 (100.0 g) and t-butyl acetoacetate (28.16 g). The mixture was gradually heated and allowed to react at 120° C. for 40 minutes and at 140° C. for two hours. A total of 14 ml of the condensate (t-butanol) was collected in the Dean-Stark adapter. The resulting viscous polyester resin was allowed to cool and subsequently collected. The polyester had a glass transition temperature (Tg) of −55.8° C.; a number average molecular weight (Mn) of 2684 g/mole; and a weight average molecular weight (Mw) of 9761 g/mole.

### Example 2. Synthesis of Self-Curable Polyester 2 (SC Polyester 2)

The next synthesis was aimed to convert the hydroxyl number of 30 mgKOH/g of the above unsaturated polyester (1) to an acetoacetate number of 30 mgKOH/g.

To a 500 mL, three-neck, round-bottom flask equipped with a mechanical stirrer, a heated partial condenser, a Dean-Stark trap, and a water condenser were added the above unsaturated polyester 1 (100.0 g) and t-butyl acetoacetate (8.45 g). The mixture was gradually heated and allowed to react at 120° C. for 40 minutes and at 140° C. for two hours. A total of 3.5 ml of the condensate (t-butanol) was collected in the Dean-Stark adapter. The resulting viscous polyester resin was allowed to cool and subsequently collected. The polyester had a glass transition temperature (Tg) of −56.5° C.; a number average molecular weight (Mn) of 2593 g/mole; a weight average molecular weight (Mw) of 8864 g/mole.

### Example 3. Synthesis of Self-Curable Polyester 3 (SC Polyester 3)

### Unsaturated Polyester 2:

A 2-L kettle with a four-neck lid was equipped with a mechanical stirrer, a thermocouple, a heated partial condenser (115° C.), a Dean-Stark trap, and a chilled condenser (15° C.). To the flask were charged neopentyl glycol (245.1 g, 2.35 mole), 2-methyl-1,3-propanediol (212.1 g, 2.35 mole), trimethylolpropane (TMP) (29.76 g, 0.22 mole), isophthalic acid (139.6 g, 0.84 mole), adipic acid (245.4 g, 1.68 mole), maleic anhydride (MA) (164.7 g, 1.68 mole), triphenylphosphite (5.18 g), and Fascat 4100 (1.56 g). The reaction temperature was increased to 150° C. at 1.4° C./min. and then to 230° C. at 0.44° C./min.; the reaction was stopped after a total of 8 hours. A total of 108 g of the distillate was collected in the Dean-Stark trap. The resulting polyester resin was allowed to cool to room temperature and subsequently collected. The polyester had an acid number of 3.6 mgKOH/g; a hydroxyl number of 89.4 mgKOH/g; a glass transition temperature (Tg) of −25° C.; a number average molecular weight (Mn) of 2069 g/mole; and a weight average molecular weight (Mw) of 7905 g/mole.

### Self-Curable Polyester 3 (SC Polyester 3):

The next synthesis was aimed to convert the hydroxyl number of 50 mgKOH/g of the above unsaturated polyester (2) to an acetoacetate number of 50 mgKOH/g.

To a 500 mL, three-neck, round-bottom flask equipped with a mechanical stirrer, a heated partial condenser, a Dean-Stark trap, and a water condenser were added the above unsaturated polyester 2 (100.0 g) and t-butyl acetoacetate (14.08 g). The mixture was gradually heated and allowed to react at 120° C. for 40 minutes and at 140° C. for two hours. A total of 7.5 ml of the condensate (t-butanol) was collected in the Dean-Stark adapter. The resulting viscous polyester resin was allowed to cool and subsequently collected. The polyester had a glass transition temperature (Tg) of −30.8° C.; a number average molecular weight (Mn) of 2564 g/mole; and a weight average molecular weight (Mw) of 8203 g/mole.

### Example 4. Synthesis of Self-Curable Polyester 4 (SC Polyester 4)

### Unsaturated Polyester 3:

A 2-L kettle with a four-neck lid was equipped with a mechanical stirrer, a thermocouple, a heated partial condenser (115° C.), a Dean-Stark trap, and a chilled condenser (15° C.). To the flask were charged neopentyl glycol (245.1 g, 2.35 mole), 2-methyl-1,3-propanediol (212.1 g, 2.35 mole), trimethylolpropane (TMP) (29.76 g, 0.22 mole), adipic acid (368.2 g, 2.52 mole), maleic anhydride (MA) (164.7 g, 1.68 mole), triphenylphosphite (5.10 g), and Fascat 4100 (1.53 g). The reaction temperature was increased to 150° C. at 1.4° C./min. and then to 230° C. at 0.44° C./min.; the reaction was stopped after a total of 10.5 hours. A total of 118 g of the distillate was collected in the Dean-Stark trap. The resulting polyester resin was allowed to cool to room temperature and subsequently collected. The polyester had an acid number of 1.9 mgKOH/g; a hydroxyl number of 85.5 mgKOH/g; a glass transition temperature (Tg) of −39.8° C.; a number average molecular weight (Mn) of 2649 g/mole; and a weight average molecular weight (Mw) of 9045 g/mole.

### Self-Curable Polyester 4 (SC Polyester 4):

The next synthesis was aimed to convert the hydroxyl number of 50 mgKOH/g of the above unsaturated polyester (3) to an acetoacetate number of 50 mgKOH/g.

To a 500 mL, three-neck, round-bottom flask equipped with a mechanical stirrer, a heated partial condenser, a Dean-Stark trap, and a water condenser were added the above unsaturated polyester 3 (100.0 g) and t-butyl acetoacetate (14.08 g). The mixture was gradually heated and allowed to react at 120° C. for 40 minutes and at 140° C. for two hours. A total of 6.5 ml of the condensate (t-butanol) was collected in the Dean-Stark adapter. The resulting viscous polyester resin was allowed to cool and subsequently collected. The polyester had a glass transition temperature (Tg) of −41.6° C.; a number average molecular weight (Mn) of 2695 g/mole; and a weight average molecular weight (Mw) of 9215 g/mole.

### Example 4. Formulation and Evaluation of Curable Compositions

Formulations 1-6 were prepared by using liquid like SC polyesters 1 and 2 without solvents. Two base catalysts were used respectively for evaluating their effects on curing; they were 1,8-diazabicyclo-[5.4.0]undec-7-ene (DBU) in n-PrOH (25 weight percent) and triethylamine (neat). As listed in Table 1, various levels of the catalysts were used, for example, 0.5%, 1%, and 2% by weight, based on the weight of the polyester.

Each polyester was mixed well with a catalyst just before the coating preparation. The coatings were prepared by applying each formulation to cold-rolled stainless steel panels with a drawdown bar. The coated panels were then allowed to dry at room temperature; the dried coatings had the thickness of about 50 μm. It was observed that the formulations in the vials could become very viscous, gel-like, and rubbery over several hours, depending on the crosslinking efficiency of the formulations. As indicated in Table 2, formulations 3 and 4 with 1% DBU were most reactive, and DBU was a more effective catalyst than triethylamine.

TABLE 1
Formulations Based on Self-Curable Polyesters

| | | | | Catalyst, DBU | Catalyst, | Catalyst |
|---|---|---|---|---|---|---|
| | | Polyester, | Polyester | in n-propanol | triethylamine, | ratio, |
| Formulation | Polyester | neat | wt., gram | (25%), gram | gram | wt. % |
| 1 | SC Polyester 1 | 100% | 5 | 0.1 | | 0.5 |
| 2 | SC Polyester 2 | 100% | 5 | 0.1 | | 0.5 |
| 3 | SC Polyester 1 | 100% | 5 | 0.2 | | 1 |
| 4 | SC Polyester 2 | 100% | 5 | 0.2 | | 1 |
| 5 | SC Polyester 1 | 100% | 5 | | 0.1 | 2 |
| 6 | SC Polyester 2 | 100% | 5 | | 0.1 | 2 |

TABLE 2
Drying Characteristics of Curable Compositions over Time at Room Temperature

| | Formulation Observation | | | | | | | | |
|---|---|---|---|---|---|---|---|---|---|
| | Right after | | | | | | | | |
| | mixing with | | | | | Coating Observation | | | |
| | the base | | | After 5 | | after one | after 3 | after 5 | |
| Formulation | catalyst | After one hour | After 3 hours | hours | overnight | hour | hours | hours | overnight |
| 1 | clear, yellow; | clear, flow very | clear, flow | same | same | wet | wet | wet | wet |
| | became highly | slowly, highly | very slowly, | | | | | | |
| | viscous | viscous | highly viscous | | | | | | |
| 2 | clear, yellow; | clear, flow very | clear, flow | same | same | wet | wet | wet | wet |
| | became highly | slowly, highly | very slowly, | | | | | | |
| | viscous | viscous | highly viscous | | | | | | |
| 3 | clear, yellow; | clear, rubbery | clear, rubbery, | rubbery, | rubbery, | wet | slightly | slightly | slightly tacky |
| | became highly | | hard | becoming | quite hard | | tacky | tacky | |
| | viscous | | | harder | | | | | |
| 4 | clear, yellow; | clear, does not | sticky gel, | rubbery, | rubbery, | wet | sticky | sticky | sticky |
| | became highly | flow, highly | does not flow | soft | becoming | | | | |
| | viscous | viscous | | | harder | | | | |
| 5 | clear, yellow; | clear, flow very | clear, flow | same | same | wet | wet | wet | wet |
| | became highly | slowly | very slowly | | | | | | |
| | viscous | | | | | | | | |
| 6 | clear, yellow; | clear, flow | clear, flow | same | same | wet | wet | wet | wet |
| | became | slowly | very slowly | | | | | | |
| | viscous | | | | | | | | |
| | immediately | | | | | | | | |

### Example 5. Formulation and Evaluation of Curable Compositions

Formulations 7-14 were prepared by using SC polyesters 3 and 4 in xylene (60%). Two base catalysts were used respectively for evaluating their effects on curing; they were 1,8-diazabicyclo-[5.4.0]undec-7-ene (DBU) in n-PrOH (25 weight percent) and triethylamine (neat). As listed in Table 3, various levels of the catalysts were used, for example, 1%, 2%, and 4% by weight, based on the weight of the polyester.

Each polyester was mixed well with a catalyst just before the coating preparation. The coatings were prepared by applying each formulation to cold-rolled stainless steel panels with a drawdown bar. The coated panels were then allowed to dry at room temperature; the dried coatings had the thickness of about 30 μm. It was observed that the formulations in the vials could become very viscous, gel-like, and rubbery over several hours, depending on the crosslinking efficiency of the formulations. As indicated in Table 4, formulations 9 and 10 with 2% DBU were most reactive, and DBU was a significantly more effective catalyst than triethylamine.

TABLE 3
Formulations Based on Self-Curable Polyesters

| | | | | Catalyst, DBU | Catalyst, | Catalyst |
|---|---|---|---|---|---|---|
| | | | Polyester | in n-propanol | triethylamine, | ratio, |
| Sample ID | Polyester ID | Polyester | wt., gram | (25%), gram | gram | wt. % |
| 7 | SC Polyester 3 | 60% | 8.3 | 0.2 | | 1 |
| 8 | SC Polyester 4 | 60% | 8.3 | 0.2 | | 1 |
| 9 | SC Polyester 3 | 60% | 8.3 | 0.4 | | 2 |
| 10 | SC Polyester 4 | 60% | 8.3 | 0.4 | | 2 |
| 11 | SC Polyester 3 | 60% | 8.3 | | 0.1 | 2 |
| 12 | SC Polyester 4 | 60% | 8.3 | | 0.1 | 2 |
| 13 | SC Polyester 3 | 60% | 8.3 | | 0.2 | 4 |
| 14 | SC Polyester 4 | 60% | 8.3 | | 0.2 | 4 |

TABLE 4
Drying Characteristics of Curable Compositions over Time at Room Temperature

| | | Formulation Observation | | | | | | | | |
|---|---|---|---|---|---|---|---|---|---|---|
| | | Right after | | | | | Coating Observation | | | |
| | | mixing with | after | | | | After | | | |
| | | the base | one | after 3 | after 5 | | one | After 3 | After 5 | |
| Formulation | Polyester | catalyst | hour | hours | hours | overnight | hour | hours | hours | overnight |
| 7 | SC | Became | slightly | viscous | viscous, light | gel/ | sticky | sticky | tacky | tacky |
| | Polyester 3 | slightly viscous | viscous | | yellow, clear | rubbery | | | | |
| 8 | SC | Became | slightly | viscous | set up, gel, | rubbery | sticky | sticky | tacky | slightly |
| | Polyester 4 | slightly viscous | viscous | | yellow, clear | | | | | tacky |
| 9 | SC | Became | viscous | set up | rubbery, light | rubbery | slightly | slightly | slightly | slightly |
| | Polyester 3 | viscous | | | yellow, clear | | tacky | tacky | tacky | tacky |
| 10 | SC | Became | viscous | set up | rubbery, | rubbery | slightly | slightly | slightly | slightly |
| | Polyester 4 | viscous | | | yellow, clear | | tacky | tacky | tacky | tacky |
| 11 | SC | fluid | fluid | fluid | fluid | slightly | wet | sticky | sticky | sticky |
| | Polyester 3 | | | | | viscous | | | | |
| 12 | SC | fluid | fluid | fluid | fluid | slightly | wet | sticky | sticky | sticky |
| | Polyester 4 | | | | | viscous | | | | |
| 13 | SC | fluid | fluid | fluid | fluid | slightly | wet | sticky | sticky | sticky |
| | Polyester 3 | | | | | viscous | | | | |
| 14 | SC | fluid | fluid | fluid | fluid | slightly | wet | sticky | sticky | sticky |
| | Polyester 4 | | | | | viscous | | | | |

### Example 6. Synthesis of Self-Curable Polyester 5 (SC Polyester 5)

### Unsaturated Polyester 4:

A 2-L kettle with a four-neck lid was equipped with a mechanical stirrer, a thermocouple, a heated partial condenser (115° C.), a Dean-Stark trap, and a chilled condenser (15° C.). To the flask were charged neopentyl glycol (245.1 g, 2.35 mole), 2-methyl-1,3-propanediol (212.1 g, 2.35 mole), trimethylolpropane (TMP) (29.76 g, 0.22 mole), isophthalic acid (418.7 g, 2.52 mole), maleic anhydride (MA) (164.7 g, 1.68 mole), triphenylphosphite (5.35 g), and Fascat 4100 (1.61 g). The reaction temperature was increased to 150° C. at 1.4° C./min. and then to 230° C. at 0.44° C./min.; the reaction was stopped after a total of 16 hours. A total of 118 g of the distillate was collected in the Dean-Stark trap. The resulting polyester was allowed to cool to room temperature and subsequently collected. The polyester had an acid number of 2.1 mgKOH/g; a hydroxyl number of 94.7 mgKOH/g; a glass transition temperature (Tg) of 21.41° C.; a number average molecular weight (Mn) of 3079 g/mole; and a weight average molecular weight (Mw) of 17199 g/mole.

### Self-Curable Polyester 5 (SC Polyester 5):

The next synthesis was aimed to convert the hydroxyl number of 50 mgKOH/g of the above unsaturated polyester (4) to an acetoacetate number of 50 mgKOH/g. To a 500 mL, three-neck, round-bottom flask equipped with a mechanical stirrer, a heated partial condenser, a Dean-Stark trap, and a water condenser were added the above unsaturated polyester 4 (100.0 g) and t-butyl acetoacetate (14.08 g). The mixture was gradually heated and allowed to react at 120° C. for 40 minutes and at 140° C. for two hours. A total of 6.5 ml of the condensate (t-butanol) was collected in the Dean-Stark adapter. The resulting viscous polyester resin was allowed to cool and subsequently collected. The polyester had a glass transition temperature (Tg) of 10.9° C.; a number average molecular weight (Mn) of 3031 g/mole; and a weight average molecular weight (Mw) of 39071 g/mole.

### Example 7. Synthesis of Self-Curable Polyester 6 (SC Polyester 6)

### Unsaturated Polyester 5:

A 2-L kettle with a four-neck lid was equipped with a mechanical stirrer, a thermocouple, a heated partial condenser (115° C.), a Dean-Stark trap, and a chilled condenser (15° C.). To the flask were charged neopentyl glycol (490.3 g, 4.71 mole), trimethylolpropane (TMP) (29.76 g, 0.22 mole), hexahydrophthalic anhydride (388.5 g, 2.52 mole), maleic anhydride (MA) (164.7 g, 1.68 mole), triphenylphosphite (5.37 g), and Fascat 4100 (1.61 g). The reaction temperature was increased to 150° C. at 1.4° C./min. and then to 230° C. at 0.44° C./min.; the reaction was stopped after a total of 16 hours. A total of 70.1 g of the distillate was collected in the Dean-Stark trap. The resulting polyester was allowed to cool to room temperature and subsequently collected. The polyester had an acid number of 3.9 mgKOH/g; a hydroxyl number of 79.9 mgKOH/g; a glass transition temperature (Tg) of 16.06° C.; a number average molecular weight (Mn) of 2323 g/mole; and a weight average molecular weight (Mw) of 17432 g/mole.

### Self-Curable Polyester 6 (SC Polyester 6):

The next synthesis was aimed to convert the hydroxyl number of 50 mgKOH/g of the above unsaturated polyester (5) to an acetoacetate number of 50 mgKOH/g. To a 500 mL, three-neck, round-bottom flask equipped with a mechanical stirrer, a heated partial condenser, a Dean-Stark trap, and a water condenser were added the above unsaturated polyester 5 (100.0 g) and t-butyl acetoacetate (14.08 g). The mixture was gradually heated and allowed to react at 120° C. for 40 minutes and at 140° C. for two hours. A total of 6.5 ml of the condensate (t-butanol) was collected in the Dean-Stark adapter. The resulting viscous polyester resin was allowed to cool and subsequently collected. The polyester had a glass transition temperature (Tg) of 6.28° C.; a number average molecular weight (Mn) of 2375 g/mole; and a weight average molecular weight (Mw) of 19197 g/mole.

### Example 8. Formulation and Evaluation of Curable Compositions

A hydroxyl functional polyester (OH polyester) with the composition of 2,2,4,4-tetramethyl-1,3-cyclobutanediol, neopentyl glycol, trimethylolpropane, hexahydrophthalic anhydride, and adipic acid was prepared. The polyester had the properties of: acid number 10 mgKOH/g, hydroxyl number 130 mgKOH/g, and Tg 2° C. This polyester did not have the functionalities required for self-curing and was used for comparison. Baking enamel formulations 15-19 were prepared respectively by using SC polyesters 5 and 6, unsaturated polyesters 4 and 5 (unsat. PEs 4 and 5), and the OH polyester above. Unsat. PEs 4 and 5 and the OH polyester were not self-curable and were used as the comparative examples. Each polyester (50 wt. % in xylene) was mixed with an amino crosslinker, CYMEL 303 available from Allnex, and an acid catalyst, p-toluenesulfonic acid (pTSA, 5 wt. % in isopropanol) at a polyester/CYMEL 303 ratio of 90/10 and the catalyst ratio of 0.5 wt. % based on the total weight of polyester and CYMEL 303. The coatings were prepared by applying each formulation to cold-rolled stainless steel test panels with a drawdown bar. The coated panels were then baked in an oven at 140° C., 120° C., and 100° C. respectively. The degree of crosslinking of the cured films (about 20 to 25 microns thickness) was determined by their solvent resistance using MEK (methyl ethyl ketone) Double Rub Method (ASTM D4752). As indicated in Table 5, formulations 15 and 16 based on self-curable polyesters had significantly higher numbers of MEK double rubs than those of formulations 17-19 based on the comparative non-self-curable polyesters.

TABLE 5
Comparison of Curing Effectiveness of Baking Enamel Formulations based on
Self-Curable Polyester and Non-Self Curable Polyesters

| | | | | | Catalyst, | | | MEK Double Rubs of the Coatings | | |
|---|---|---|---|---|---|---|---|---|---|---|
| | | | Polyester | CYMEL | pTSA in | Polyester/ | Catalyst | Baked at | Baked at | Baked at |
| | | Polyester | solution | 303, | isopropanol | CYMEL | ratio, | 140° C. | 120° C. | 100° C. |
| Formulation | Polyester | Solution | wt., gram | gram | (5%), gram | 303 | wt. % | for 30 min | for 30 min | for 30 min |
| 15 | SC Polyester 5 | 50% in | 9 | 0.5 | 0.5 | 90/10 | 0.5 | 130 | 250 | 400 |
| | | xylene | | | | | | | | |
| 16 | SC Polyester 6 | 50% in | 9 | 0.5 | 0.5 | 90/10 | 0.5 | 400 | 500 | 250 |
| | | xylene | | | | | | | | |
| 17 | OH Polyester | 50% in | 9 | 0.5 | 0.5 | 90/10 | 0.5 | 115 | 135 | 100 |
| | (comparative) | xylene | | | | | | | | |
| 18 | Unsat. PE 4 | 50% in | 9 | 0.5 | 0.5 | 90/10 | 0.5 | 130 | 180 | 85 |
| | (comparative) | xylene | | | | | | | | |
| 19 | Unsat. PE 5 | 50% in | 9 | 0.5 | 0.5 | 90/10 | 0.5 | 115 | 180 | 80 |
| | (comparative) | xylene | | | | | | | | |

### Example 9. Synthesis of Self-Curable Polyester 7 (SC Polyester 7)

A 2-L kettle with a four-neck lid was equipped with a mechanical stirrer, a thermocouple, a heated partial condenser (115° C.), a Dean-Stark trap, and a chilled condenser (15° C.). To the flask were charged neopentyl glycol (245.1 g, 2.35 mole), 2-methyl-1,3-propanediol (212.1 g, 2.35 mole), trimethylolpropane (TMP) (29.76 g, 0.22 mole), dimethyl malonate (221.9 g, 1.68 mole), adipic acid (122.7 g, 0.84 mole), maleic anhydride (MA) (164.7 g, 1.68 mole), triphenylphosphite (4.98 g), and Fascat 4100 (1.49 g). The reaction temperature was increased to 150° C. at 1.4° C./min. and then to 230° C. at 0.44° C./min.; the reaction was stopped after a total of 6 hours. A total of 138 g of the distillate was collected in the Dean-Stark trap (Note: Some of the volatile methanol condensate was lost). The resulting polyester was allowed to cool to room temperature and subsequently collected. The polyester had a glass transition temperature (Tg) of −43.36° C.; a number average molecular weight (Mn) of 1027; and a weight average molecular weight (Mw) of 2583.

### Example 10. Formulation and Evaluation of Curable Compositions

Formulations 20-22 were prepared by mixing SC polyester 7 (100%) with the basic catalyst, 1,8-diazabicyclo-[5.4.0]undec-7-ene (DBU). Neat (100%) DBU was used for formulations 20 and 22, while a 25 weight % solution of DBU in n-propanol was used for formulation 21. As listed in Table 6, one or two weight %, based on the polyester, of the catalyst was used. The formulations were then allowed to cure in the vials at room temperature for 2 days. The formulations with and without the basic catalyst were then tested for melt viscosity by a cone and plate viscomether (CAP 2000 Viscometer by BYK Gardner). It was found that the SC polyester without the catalyst (formulation 23 below) had the viscosity of 2.5 Pascal-second, while the ones with the catalyst had significantly higher viscosity as shown in Table 6 (measured at 80° C. using spindle cone No. 5 and speed 900 rpm), indicating the occurrence of crosslinking in the presence of the basic catalyst. Formulation 22 had become rubbery and the viscosity could not be measured. The result also showed that the curing was slower when DBU in n-propanol was used (formulations 21 vs 20), indicating the blocking effect of an alcohol on the catalyst.

TABLE 6
Formulations and Curing of Self-Curable Polyester

| | | | | | | | CAP |
|---|---|---|---|---|---|---|---|
| | | | | | | | viscosity, |
| | | | | | Catalyst, | | Pascal- |
| | | | | Catalyst, | DBU in n- | | second |
| | | | | DBU | propanol | Catalyst | (after 2 |
| | | Polyester, | Polyester | (100%), | (25%), | ratio, | days at |
| Formulation | Polyester | neat | wt., gram | gram | gram | wt. % | RT) |
| 20 | SC | 100% | 5 | 0.05 | | 1 | 2.6 |
| | Polyester 7 | | | | | | |
| 21 | SC | 100% | 5 | | 0.2 | 1 | 1.0 |
| | Polyester 7 | | | | | | |
| 22 | SC | 100% | 5 | 0.1 | | 2 | rubbery |
| | Polyester 7 | | | | | | |
| 23 | SC | 100% | 5 | None | | N/A | 0.25 |
| (comparative) | Polyester 7 | | | | | | |

In a separate experiment, SC polyester 7 (100%) was mixed with an amino crosslinker, CYMEL 303 available from Allnex, and an acid catalyst, p-toluenesulfonic acid (pTSA, 5 wt. % in isopropanol) at polyester/CYMEL 303 ratios of 80/20 and 70/30 respectively and the catalyst ratio of 0.5 wt. % based on the total weight of polyester and CYMEL 303. The coatings were prepared by applying the formulations thus prepared to cold-rolled stainless steel test panels with a drawdown bar. The coated panels were then baked in an oven at 140° C., 120° C., and 100° C. respectively. The degree of crosslinking of the cured films (about 40 to 50 microns thickness) was determined by their solvent resistance using MEK (methyl ethyl ketone) Double Rub Method (ASTM D4752). It was found that all the coatings had MEK double rubs of 200 or greater (Table 7), indicating effective crosslinking even at a low bake temperature of 100° C.

TABLE 7
Baking Enamel Formulations Based on Self-Curable Polyester

| | | Polyester | | Catalyst, | | | | | |
|---|---|---|---|---|---|---|---|---|---|
| | | (100%) | | pTSA in | Polyester/ | | MEK Double Rubs of the Coatings | | |
| | | wt., | CYMEL | isopropanol | CYMEL | Catalyst | Baked at 140° C. | Baked at 120° C. | Baked at 100° C. |
| Formulation | Polyester | gram | 303, gram | (5%), gram | 303 | ratio, wt. % | for 30 min | for 30 min | for 30 min |
| 24 | SC | 16 | 4 | 2 | 80/20 | 0.5 | 260 | 200 | 200 |
| | Polyester 7 | | | | | | | | |
| 25 | SC | 14 | 6 | 2 | 70/30 | 0.5 | 500 | 500 | 210 |
| | Polyester 7 | | | | | | | | |

### Example 11. Synthesis of Self-Curable Polyester 8 (SC Polyester 8)

### Unsaturated Polyester 6:

A 2-L kettle with a four-neck lid was equipped with a mechanical stirrer, a thermocouple, a heated partial condenser (115° C.), a Dean-Stark trap, and a chilled condenser (15° C.). To the flask were charged neopentyl glycol (265.6 g, 2.55 mole), trimethylolpropane (32.24 g, 0.24 mole), isophthalic acid (418.7 g, 2.52 mole), and Fascat 4100 (1.87 g). The reaction temperature was increased to 150° C. at 1.4° C./min. and then to 230° C. at 0.44° C./min. The reaction was allowed to react for 5 hours, and the temperature was lowered to 170° C. To the reaction mixture was then added maleic anhydride (MA) (164.7 g, 1.68 mole). The reaction temperature was gradually increased to 230° C. at 1.5° C./min. and held for two hours. The resulting polyester was allowed to cool to room temperature and subsequently collected. The polyester had an acid number of 7.8 mgKOH/g; a hydroxyl number of 98.5 mgKOH/g; a glass transition temperature (Tg) of 41.91° C.; a number average molecular weight (Mn) of 1827 g/mole; and a weight average molecular weight (Mw) of 4580 g/mole.

Self-Curable Polyester 8 (SC Polyester 8):

The goal of this example was to convert the hydroxyl number of 50 mgKOH/g of the above unsaturated polyester (6) to an acetoacetate number of 50 mgKOH/g. To a 500 mL, three-neck, round-bottom flask equipped with a mechanical stirrer, a heated partial condenser, a Dean-Stark trap, and a water condenser were added the above unsaturated polyester 6 (100.0 g) and t-butyl acetoacetate (14.08 g). The mixture was gradually heated and allowed to react at 120° C. for 40 minutes and at 140° C. for two hours. A total of 6.5 ml of the condensate (t-butanol) was collected in the Dean-Stark adapter. The resulting viscous polyester resin was allowed to cool and subsequently collected. The polyester had a glass transition temperature (Tg) of 29.3° C.; a number average molecular weight (Mn) of 2004 g/mole; and a weight average molecular weight (Mw) of 4627 g/mole.

### Example 12. Formulation and Evaluation of Curable Compositions

Formulations 26 and 27 were prepared by using SC polyesters 8 in xylene (50%). As listed in Table 8, two levels of the catalyst, DBU (25 weight % in n-propanol), were used. They are 1% and 2% by weight, based on the weight of the polyester.

The polyester was mixed well with the catalyst just before the coating preparation. The coatings were prepared by applying each formulation to cold-rolled stainless steel panels with a drawdown bar. The coated panels were then allowed to dry at room temperature; the dried coatings had the thickness of about 25 μm. It was observed that the formulations in the vials remained fluid and did not have significant changes in appearance after 3 days, while the coatings became tack free in 3 to 5 hours with high gloss.

TABLE 8
Formulations and Curing of Self-Curable Polyester

| | | | | Catalyst, | | Formulation Observation | | | Coating Observation | | |
|---|---|---|---|---|---|---|---|---|---|---|---|
| | | | | DBU in n- | | | Obser- | Obser- | Coating | Coating | Coating |
| | | | | propanol | Catalyst | Observation | vation | vation | observation | observation | observation |
| | | Polyester | Polyester | (25%), | ratio, | after one | after 5 | after 3 | after one | after 3 | after 5 |
| Formulation | Polyester | Solution | wt., gram | gram | wt. % | hour | hours | days | hour | hours | hours |
| 26 | SC | 50% in | 10 | 0.2 | 1 | fluid, clear, | same | same | slightly | slightly | Tack Free |
| | Polyester 8 | xylene | | | | almost no | | | tacky | tacky | |
| | | | | | | color | | | | | |
| 27 | SC | 50% in | 10 | 0.4 | 2 | fluid, clear, | same | same | slightly | tack free | tack free |
| | Polyester 8 | xylene | | | | light yellow | | | tacky | | |

The invention has been described in detail with particular reference to preferred embodiments thereof, but it will be understood that variations and modifications can be effected within the spirit and scope of the invention.

We claim:

1. A composition comprising:
A. a polyester comprising the residues of
I. a first compound comprising an α,β-unsaturated carboxyl compound having at least one carboxylic acid or anhydride group having at least one unsaturation in the position that is α,β relative to said carboxylic acid or anhydride group and not located on an aromatic ring; and
II. a second compound having an activated methylene or methine group; and
B. a basic catalyst.

2. The composition of claim 1 wherein said second compound is selected from the group consisting of diketene, β-ketotoacetate, and malonate and mixtures thereof.

3. The composition of claim 1, wherein said first compound is selected from the group comprising maleic anhydride, maleic acid, fumaric acid, itaconic acid, itaconic anhydride and mixtures thereof.

4. The composition of claim 1, wherein said second compound is one or more selected from the group comprising diketene, t-butyl acetoacetate, methyl acetoacetate, ethyl acetoacetate, n-propyl acetoacetate, isopropyl acetoacetate, n-butyl acetoacetate, malonic acid, dimethyl malonate, diethyl malonate and mixtures thereof.

5. A composition comprising:
A. an acetoacetate-functionalized unsaturated polyester comprising the reaction product of:
I. an unsaturated polyester in an amount from about 50 to about 97 weight percent, based on the total weight of (I) and (II), comprising the residues of:
a. a hydroxyl component comprising:
i. a diol in an amount ranging from 70 to 100 mole percent, based on the total moles of (i) and (ii), and
ii. a polyol in an amount ranging from 0 to 30 mole percent, based on the total moles of (i) and (ii),
b. an α,β-unsaturated carboxyl compound, and
c. optionally a carboxyl component other than said α,β-unsaturated carboxyl compound (b), comprising a polycarboxylic acid compound, a derivative of polycarboxylic acid compound, or a combination thereof, and
II. an alkyl acetoacetate and/or diketene in an amount ranging from about 3 to about 50 weight percent, based on the total weight of (I) and (II); and
B. a basic catalyst.

6. The composition of claim 5, wherein said α,β-unsaturated carboxyl compound (b) is in an amount of 35 to 70 mole percent based on the total moles of the carboxyl components, (b) and (c).

7. The composition of claim 5, wherein said unsaturated polyester (I) is in an amount of 70 to 90 weight percent and said alkyl acetoacetate and/or diketene (II) is in an amount of 10 to 30 weight percent, all based on the total weight of (I) and (II).

8. The composition of claim 5, wherein said alkyl acetoacetate (II) is t-butyl acetoacetate.

9. A composition comprising:
A. a polyester comprising the residues of:
a. a hydroxyl component comprising:
i. a diol in an amount ranging from 70 to 100 mole percent, based on the total moles of (i) and (ii), and
ii. a polyol in an amount ranging from 0 to 30 mole percent, based on the total moles of (i) and (ii),
b. an α,β-unsaturated carboxyl compound,
c. malonic acid, its ester, or a combination thereof, and
d. optionally a carboxyl component other than said α,β-unsaturated carboxyl compound (b) and other than said malonic acid and/or its ester (c), comprising a polycarboxylic acid compound, a derivative of polycarboxylic acid compound, or a combination thereof; and
B. a basic catalyst.

10. The composition of claim 9, wherein said malonic acid and/or its ester (c) is in an amount of 20 to 60 mole percent based on the total moles of the carboxyl components, (b), (c), and (d).

11. The composition of claim 9, wherein the α,β-unsaturated carboxyl compound (b) is in an amount of 35 to 70 mole percent based on the total moles of (b), (c), and (d).

12. The composition of claim 9, wherein the α,β-unsaturated carboxyl compound (b) is in an amount of 30 to 50 mole percent, malonic acid (c) is in an amount of 30 to 50 mole percent, and the carboxyl compound (d) is in an amount of 0 to 40 mole percent, based on the total moles of the carboxyl components, (b), (c), and (d).

13. The composition of claim 1, wherein the basic catalyst (B) is one or more selected from the group comprising 1,8-diazabicyclo-[5.4.0]undec-7-ene (DBU), 1,5-diazabicyclo[4.3.0]non-5-ene (DBN), 1,5,7-triazabicyclo[4.4.0]dec-5-ene (TBD), 7-methyl-1,5,7-triazabicyclo[4.4.0]dec-5-ene (MTBD), 1,1,3,3-tetramethylguanidine (TMG), 1,4-diazabicyclo[2.2.2]octane (DABCO), triethylamine, N,N-dimethylethanolamine, ammonium hydroxide, triphenyl phosphine, and tributyl phosphine.

14. The composition of claim 1, wherein the basic catalyst (B) is one or more selected from the group consisting of 1,8-diazabicyclo-[5.4.0]undec-7-ene (DBU), 1,5-diazabicyclo[4.3.0]non-5-ene (DBN), 1,5,7-triazabicyclo[4.4.0]dec-5-ene (TBD), 7-methyl-1,5,7-triazabicyclo[4.4.0]dec-5-ene (MTBD), and 1,1,3,3-tetramethylguanidine (TMG).

15. The composition of claim 1, wherein the basic catalyst (B) is in amount ranging from 0.5 to 5 weight percent based on the weight of the self-curable polyester (A).

16. The composition of claim 1 further comprising one or more organic solvents.

17. The composition of claim 16 wherein said organic solvents are selected from the group comprising xylene, methyl amyl ketone, methyl ethyl ketone, 2-butoxyethanol, ethyl-3-ethoxypropionate, toluene, propanol, butanol, cyclopentanone, cyclohexanone, ethyl acetate, and butyl acetate.

18. A composition comprising:
A. a polyester comprising the residues of
I. a first compound having an α,β-unsaturated group; and
II. a second compound having an activated methylene or methine group;
wherein said first compound is an α,β-unsaturated carboxyl compound having at least one carboxylic acid or anhydride group, and having at least one unsaturation in the position that is α,β relative to said carboxylic acid or anhydride group and not located on an aromatic ring; and
wherein said second compound is one or more compounds selected from the group consisting of diketene, β-ketotoacetate, and malonate;
B. an amino crosslinker; and
C. an acid catalyst.

19. The composition of claim 18, wherein said amino crosslinker is present in an amount of from about 10 to about 30 weight percent, based on the total weight of (A) and (B).

20. The composition of claim 18 wherein said amino crosslinker is hexamethoxymethylmelamine, tetramethoxymethylbenzoguanamine, tetramethoxymethyl urea, mixed butoxy/methoxy substituted methylmelamines, or a mixture thereof.

21. The composition of claim 18 wherein said acid catalyst is p-toluenesulfonic acid, dinonylnaphthalene disulfonic acid, dodecylbenzenesulfonic acid, phosphoric acid, or mixtures thereof.
